(19) United States
(12) Patent Application Publication
(10) Pub. No.: US 2007/0291976 A1
(43) Pub. Date: Dec. 20, 2007

(54) Electrodynamic exciter

(75) Inventor: Hiroo Kajiwara, Fujiyoshida-shi (JP)

Correspondence Address: BRINKS HOFER GILSON & LIONE, P.O. BOX 10395, CHICAGO, IL, 60610, US

(73) Assignee: CITIZEN ELECTRONICS CO., LTD.

(21) Appl. No.: 11/810,177

(22) Filed: Jun. 5, 2007

(30) Foreign Application Priority Data
Jun. 6, 2006 (JP) JP2006-156875

(51) Int. Cl. H04R 9/06; H04R 11/02; H04R 1/00

(52) U.S. Cl. 381/400; 381/396

(57) ABSTRACT

An electrodynamic exciter has a tubular frame, a magnetic circuit assembly, a voice coil, and first and second suspensions axially vibratably supporting the magnetic circuit assembly and the voice coil, respectively, in the frame. One end of the frame is secured to a diaphragm to form an air chamber between the second suspension and the diaphragm. The vibration of the voice coil is transmitted to the diaphragm from the second suspension through the frame and also from the second suspension through the air chamber. The air chamber functions as an air spring or an air damper. Thus, vibrations of the voice coil in the mid and high frequency audio range are efficiently transmitted to the diaphragm, and the sound pressure level of the diaphragm in the mid and high frequency audio range is increased.

This application claims priority under 35 U.S.C. §119 to Japanese Patent Application No. JP2006-156875 filed Jun. 6, 2006, the entire content of which is hereby incorporated by reference.

### BACKGROUND OF THE INVENTION

1. Field of the Invention

The present invention relates to electrodynamic exciters and, more particularly, to an electrodynamic exciter that is provided to be used with a transparent plate for protecting the display surface of a liquid crystal display panel in portable information devices, such as cellular phones, or provided to be used with a housing of such a device to vibrate the transparent plate or the housing and thereby producing a sound output.

2. Description of the Related Art

Electrodynamic exciters for use in portable information devices to provide a sound output include an electrodynamic exciter disclosed, for example, in Japanese Patent Application Publication No. 2005-354297.

The electrodynamic exciter disclosed in this publication has a magnetic circuit assembly including a cup-shaped yoke and a combination of a magnet and a top plate that are stacked on the bottom in the yoke. A voice coil is concentrically inserted in an annular magnetic gap formed between the inner peripheral surface of the yoke and the top plate. The magnetic circuit assembly and the voice coil are disposed in a cup-shaped frame placed in inverted relation to the yoke so as to be concentric with respect to the frame. The magnetic circuit assembly is supported by an annular first suspension extending between the bottom surface of the yoke and the opening edge of the frame so as to be vibratable relative to the frame in the axial direction thereof. The voice coil is supported by an annular second suspension extending between the voice coil and the inner surface of the frame so as to be vibratable relative to the frame in the axial direction of thereof.

The electrodynamic exciter is provided with a diaphragm by securing the end wall of the frame to the diaphragm.

When an electric signal having a frequency in the audio frequency range is applied to the voice coil, the voice coil and the magnetic circuit assembly magnetically interact with each other and are each vibrated in the axial direction, whereby the diaphragm is vibrated to generate sound.

Vibrations in the low frequency audio range are transmitted to the diaphragm mainly through a vibration system including the magnetic circuit assembly having a large mass and the first suspension. Vibrations in the mid and high frequency audio range are transmitted to the diaphragm mainly through a vibration system including the voice coil having a small mass and the second suspension.

In the above-described electrodynamic exciter, however, vibrations in the mid and high frequency audio range needs to be more transmitted to the diaphragm to improve the sound pressure level in the mid and high frequency audio range.

### SUMMARY OF THE INVENTION

An object of the present invention is to solve the above-described disadvantages of the related art and to provide an electrodynamic exciter capable of obtaining a sufficiently-high sound pressure level at mid and high band audio frequencies on a reproduction frequency characteristic curve and thus capable of obtaining a wide reproduction frequency band.

The present invention provides an electrodynamic exciter including a tubular frame (denoted by reference numeral 12 in the following embodiments). A magnetic circuit assembly (20) is disposed in the frame. A first suspension (18) supports the magnetic circuit assembly vibratably in the axial direction of the frame. A voice coil (28) is disposed in the frame to extend in the axial direction and functionally connected to the magnetic circuit assembly (20). A sheet-shaped second suspension (14) is provided in the frame so as to intersect the axial direction of the frame. The second suspension has a first surface facing an opening at one end of the frame and a second surface facing the magnetic circuit assembly at a side opposite to the first surface. The second suspension (14) supports the voice coil (28) on the second surface so that the voice coil is vibratable in the axial direction of the frame. When an electric signal is applied to the voice coil (28), the voice coil (28) and the magnetic circuit assembly (20) are each vibrated in the axial direction of the frame by magnetic interaction between the voice coil (28) and the magnetic circuit assembly (20).

The electrodynamic exciter (10) is secured to a diaphragm (16) so as to close the opening of the frame (12), whereby an air chamber (32) is formed between the diaphragm (16) and the second suspension (14). With this structure, the vibration of the magnetic circuit assembly (20) is transmitted to the diaphragm (16) through the first suspension (18) and the frame (12). The vibration of the voice coil (28) is transmitted to the diaphragm (16) through the second suspension (14) and the frame (12) and also transmitted to the diaphragm (16) through the second suspension (14) and the air chamber (32). The foregoing conventional electrodynamic exciter has no air chamber (32) formed between the second suspension (14) and the diaphragm (16) and hence has no vibration transmission system that transmits vibration through the air chamber (32). The electrodynamic exciter (10) is characterized in this regard. The magnetic circuit assembly (20) has a large mass in comparison to the voice coil 28. Therefore, the vibration system that transmits vibration from the magnetic circuit assembly (20) to the diaphragm (16) has a lower natural frequency than that of the vibration system that transmits vibration from the voice coil (28) to the diaphragm (16). For this reason, when an electric signal having a frequency in the low frequency audio range is applied to the voice coil (28), the diaphragm (16) is vibrated mainly by vibration from the magnetic circuit assembly (20). In contrast, when an electric signal having a frequency in the mid and high frequency audio range is applied to the voice coil (28), the diaphragm (16) is vibrated mainly by vibration from the voice coil (28). In this case, the first vibration transmission system including the second suspension (14) and the frame (12) and the second vibration transmission system including the second suspension (14) and the air chamber (32) are parallel to each other with respect to the diaphragm (16). The air chamber (32) of the second vibration transmission system functions as an air damper or an air spring. Accordingly, as the vibration frequency of the voice coil (28) increases, the vibration transmissibility becomes high, and the diaphragm (16) is vibrated with an increased amplitude, as compared to the foregoing conventional electrodynamic exciter having no such an element. Consequently, the frequency characteristic curve (46) of the electrodynamic exciter (10) has a high sound pressure level in a frequency band of not lower than 1000 Hz, as compared to the frequency characteristic curve (44) of the conventional electrodynamic exciter. Thus, the problems with the foregoing conventional electrodynamic exciter can be solved. In addition, because of the presence of the air chamber, the second suspension is subjected to the air pressure in the air chamber when it vibrates. Thus, the air chamber functions to suppress the amplitude of vibration of the second suspension. This prevents the voice coil and the second suspension from vibrating with an excessively large amplitude when a large electric signal is applied to the voice coil. Hence, it is possible to prevent damage to the voice coil and also prevent the vibration from becoming distorted.

In addition, the present invention provides an electrodynamic exciter (100) including a tubular frame (12). A magnetic circuit assembly (20), which generates a magnetic field, is disposed in the frame (12). A first suspension (18) supports the magnetic circuit assembly (20) vibratably in the axial direction of the frame (12). A voice coil (28) is disposed in the frame (12) to extend in the axial direction and functionally connected to the magnetic circuit assembly (20). The electrodynamic exciter (100) further includes a sheet-shaped second suspension (14) having a peripheral edge portion secured along the peripheral edge of an opening at one end of the frame (12) so that the second suspension (14) closes the opening. The second suspension (14) has a first surface facing outside the frame and a second surface facing the magnetic circuit assembly at a side opposite to the first surface, and supports the voice coil (28) on the second surface so that the voice coil is vibratable in the axial direction of the frame. Further, the electrodynamic exciter (100) includes a cap-like member (35) having a diaphragm securing surface portion (35b) extending to intersect the axis of the frame at a position outward of the opening at the one end of the frame. The diaphragm securing surface portion has an inside surface facing the second suspension and an outside surface opposite to the inside surface. The inside surface forms an air chamber (32) between itself and the first surface of the second suspension. The outside surface is secured to a diaphragm. When an electric signal is applied to the voice coil (28), the voice coil (28) and the magnetic circuit assembly (20) are vibrated in the axial direction of the frame (12) by magnetic interaction between the voice coil (28) and the magnetic circuit assembly (20), whereby the diaphragm (16) is vibrated through a vibration transmission path including the air chamber (32).

The cap-like member (35) of the electrodynamic exciter (100) is provided to prevent breakage of the second suspension in the assembling process of the electrodynamic exciter or on other occasions. The electrodynamic exciter (100) is substantially the same in operation, function, characteristics, etc. as the electrodynamic exciter 10 except that the cap-like member is provided.

Preferably, a vent opening that vents the interior of the air chamber to outside air is provided to prevent generation of an excessive pressure in the air chamber when the second suspension (14) vibrates.

Specifically, the vent opening may be formed in the second suspension.

Preferably, the vent opening is formed in the central portion of the second suspension.

Specifically, the second suspension has an outer peripheral edge portion secured to the peripheral edge of the opening at the one end of the frame, and the cap-like member has an outer peripheral edge portion secured onto the outer peripheral edge portion of the second suspension.

The cap-like member may be formed from a sheet-shaped metallic material.

The diaphragm securing surface portion of the cap-like member has substantially the same size as a portion of the second suspension that is radially inward of the outer peripheral edge portion of the second suspension.

The diaphragm may be a transparent plate for protecting the display surface of a liquid crystal display panel or an electroluminescence display panel, for example.

The above and other objects, features and advantages of the present invention will become more apparent from the following description of the preferred embodiments thereof, taken in conjunction with the accompanying drawings.

### BRIEF DESCRIPTION OF THE DRAWINGS

FIG. 1 is a sectional view of an electrodynamic exciter according to a first embodiment of the present invention.

FIG. 2 is a plan view of a second suspension of the electrodynamic exciter.

FIG. 3 is a plan view of a first suspension of the electrodynamic exciter.

FIG. 4 is a plan view of a yoke of the electrodynamic exciter.

FIG. 5 is a plan view of a transparent plate to which the electrodynamic exciter is secured.

FIG. 6 is a sectional view of an electrodynamic exciter according to a second embodiment of the present invention.

FIG. 7 is a graph showing the relationship between the frequency and sound pressure in the electrodynamic exciter according to the first embodiment in comparison to a conventional electrodynamic exciter.

### DESCRIPTION OF THE PREFERRED EMBODIMENTS

Embodiments of the electrodynamic exciter according to the present invention will be described below in detail with reference to the accompanying drawings.

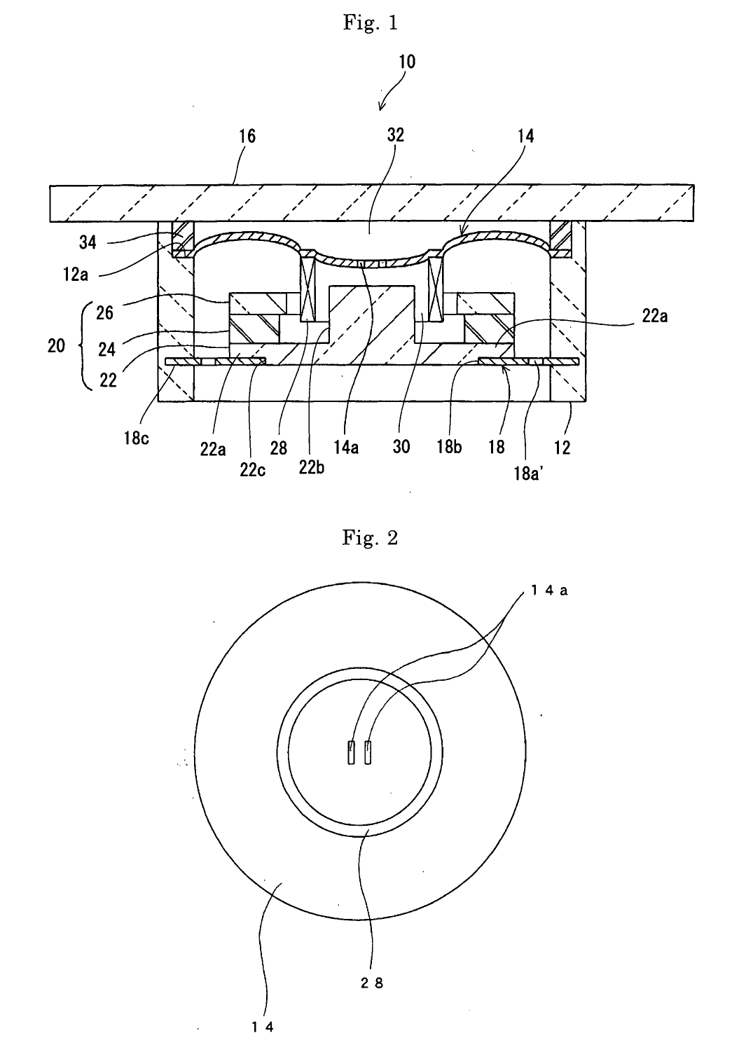

FIGS. 1 to 5 show an electrodynamic exciter 10 according to a first embodiment of the present invention.

The electrodynamic exciter 10 has a tubular frame 12, a magnetic circuit assembly 20, a first suspension 18 supporting the magnetic circuit assembly 20 vibratably in the axial direction of the frame 12, a voice coil 28 functionally connected to the magnetic circuit assembly 20, and a second suspension 14 supporting the voice coil 28 vibratably in the axial direction of the frame 12. The electrodynamic exciter 10 is provided with a diaphragm 16 so as to close an opening at one end of the frame 12.

The magnetic circuit assembly 20 has an annular magnet 24, a yoke member 22 supporting the magnet 24, and an annular top plate 26 secured onto the magnet 24.

The yoke member 22 has, as shown in FIGS. 1 and 4, a disk-shaped portion 22d, a circular columnar portion 22b provided in the center of the top of the disk-shaped portion 22d, and a pair of projections 22a extending radially outward from mutually diametrically opposing positions on the disk-shaped portion 22d. The projections 22a are thinner than the disk-shaped portion 22d. Step portions 22c are formed between the lower side of the disk-shaped portion 22d and the respective lower sides of the projections 22a. The inner peripheral edge portion of the first suspension 18 is secured to the lower sides of the projections 22a, and the inner peripheral surface 18b of the first suspension 18 is secured to the step portions 22c by welding or the like.

The yoke member 22 and the top plate 26 are both preferably made from a metallic material of high permeability, e.g. pure iron. The magnet 24 and the top plate 26 are stacked on the yoke member 22 and secured to each other.

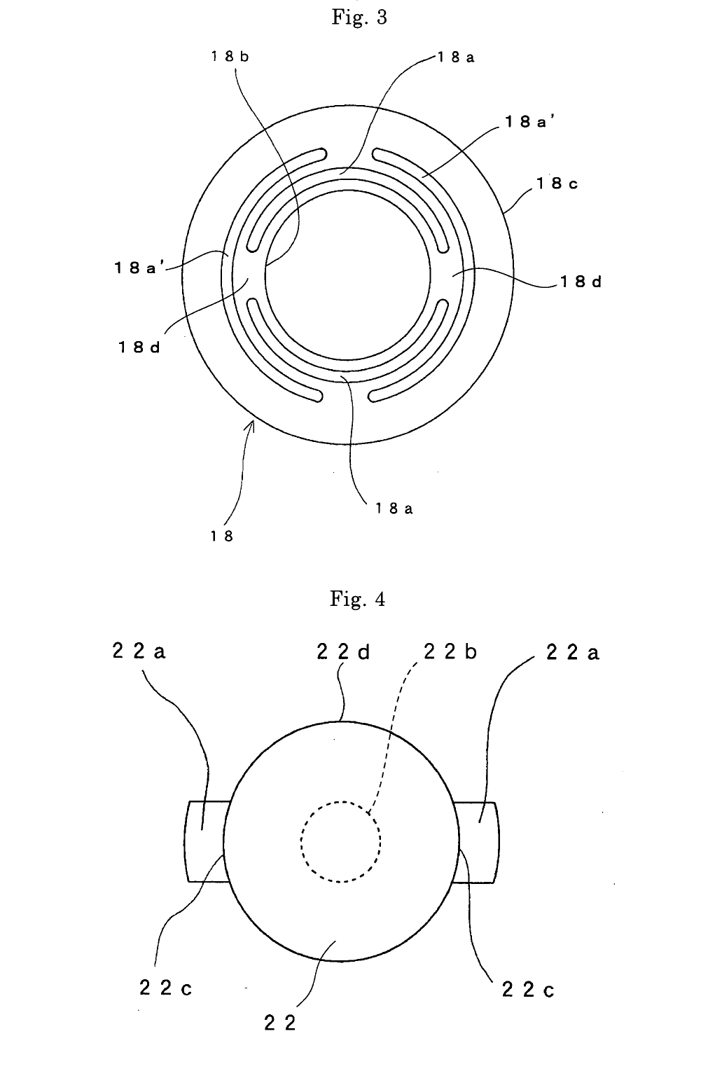

The first suspension 18 is formed from a resilient, sheet-shaped metallic material, e.g. stainless steel (SUS304). As shown in FIG. 3, the first suspension 18 is formed in an annular shape as a whole. The first suspension 18 has a pair of first arcuate slits 18a and a pair of second arcuate slits 18a′ provided in order from the inner peripheral surface 18b side toward the radially outer side of the first suspension 18. The first arcuate slits 18a and the second arcuate slits 18a′ are spaced from each other in the radial direction of the first suspension 18. The outer peripheral edge portion of the first suspension 18 is buried in the wall surface of the frame 12 molded of a resin or the like. The first suspension 18 is provided to extend across the interior of the frame 12 as a whole. Portions 18d of the suspension 18 that circumferentially extend between the first arcuate slits 18a are secured to the respective lower sides of the projections 22a of the yoke member 22 to support the yoke member 22 vibratably in the axial direction of the frame 12. In the illustrated example, the height of the step portions 22c is substantially the same as the thickness of the suspension 18. It should be noted that the first suspension 18 can be made from not only a metallic material but also a resin material.

The second suspension 14 is made from a sheet-shaped member of paper, a resin or a metal. As shown in FIGS. 1 and 2, the second suspension 14 is formed in a circular shape as a whole. The outer peripheral edge portion of the suspension 14 is secured to a step portion 12a formed on the inner periphery at the upper end (as viewed in FIG. 1) of the frame 12 and further secured to the frame 12 with an annular securing member 34 made of a resin or metallic material. The second suspension 14 supports the voice coil 28 concentrically with respect to the circular columnar portion 22b so that an annular magnetic gap 30 is formed between the outer peripheral surface of the circular columnar portion 22b in the magnetic circuit assembly 20 and the inner peripheral surface of the top plate 26. The portion of the second suspension 14 that is radially inward of the voice coil 28 is curved downward (as viewed in FIG. 1). The portion of the suspension 14 that is radially outward of the voice coil 28 is curved upward. The central portion of the second suspension 14 is formed with a pair of small rectangular openings 14a extending therethrough.

The electrodynamic exciter according to the first embodiment arranged as stated above is provided with the diaphragm 16 by securing the upper end edge (as viewed in FIG. 1) of the frame 12 to the diaphragm 16 so that an air chamber 32 is formed between the diaphragm 16 and the second suspension 14.

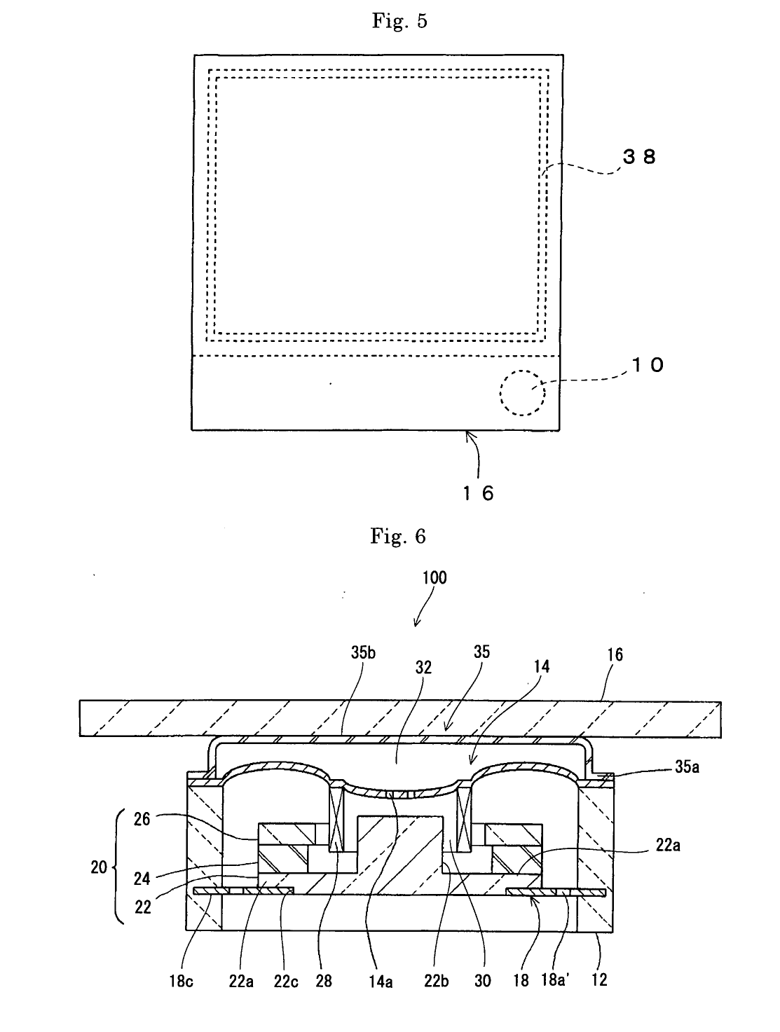

The diaphragm 16 is, for example, a transparent plate that is provided over the display surface of an information-displaying liquid crystal display panel of a cellular phone, a personal computer, an electronic dictionary, etc. to protect the liquid crystal display panel. FIG. 5 shows the way in which the electrodynamic exciter 10 is provided with such a transparent plate.

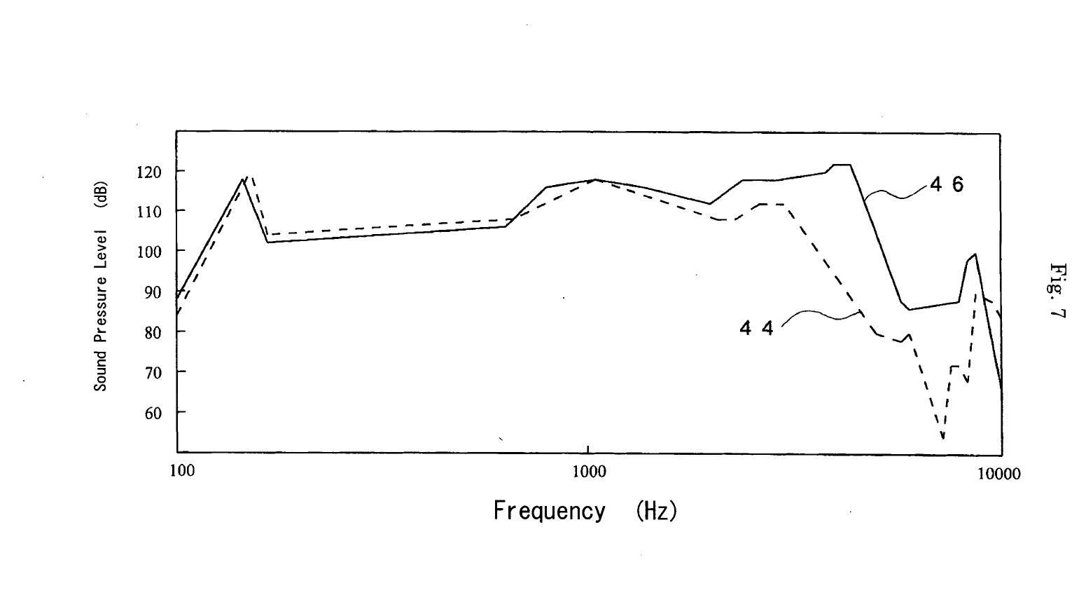

FIG. 6 shows a second embodiment of the electrodynamic exciter according to the present invention.

The electrodynamic exciter 100 of the second embodiment has basically the same structure as that of the electrodynamic exciter 10 according to the foregoing first embodiment. The same constituent elements of the electrodynamic exciter 100 as those of the electrodynamic exciter 10 are denoted by the same reference numerals as used in the first embodiment, and a detailed description thereof is omitted herein.

The electrodynamic exciter 100 differs from the electrodynamic exciter 10 in that a cap-like member 35 is provided to protect the second suspension 14. The cap-like member 35 is made from a sheet-shaped metallic material, e.g. stainless steel (SUS304).

In the electrodynamic exciter 100, the outer peripheral edge portion of the second suspension 14 is secured to the upper end surface of the frame 12. The cap-like member 35 is formed in a shallow pan shape as a whole. That is, the cap-like member 35 has a peripheral edge portion 35a secured onto the outer peripheral edge portion of the second suspension 14 and a diaphragm securing surface portion 35b extending to intersect the axis of the frame 12 at a position above the upper end surface of the frame 12 and secured to the diaphragm 16. The cap-like member 35 forms the air chamber 32 between itself and the second suspension 14.

In the electrodynamic exciter 100, the cap-like member 35 provided as stated above prevents a risk of breakage of the second suspension 14 in the assembling process of the electrodynamic exciter 100 or on other occasions.

Next, the operation of the above-described electrodynamic exciters will be explained.

The operation of the electrodynamic exciter 10 and that of the electrodynamic exciter 100 are basically the same. The following description will be made mainly of the operation of the electrodynamic exciter 10.

In the electrodynamic exciter 10 of the present invention, when an electric signal having a frequency in the audio frequency range, for example, is applied to the voice coil 28, the voice coil 28 and the magnetic circuit assembly 20 are each vibrated in the axial direction of the frame 12 by magnetic interaction therebetween.

The vibration of the magnetic circuit assembly 20 is transmitted to the diaphragm 16 through the first suspension 18 and the frame 12.

The vibration of the voice coil 28 is transmitted to the diaphragm 16 through the second suspension 14 and the frame 12 and also transmitted to the diaphragm 16 through the second suspension 14 and the air chamber 32. The foregoing conventional electrodynamic exciter has no air chamber formed between the second suspension and the diaphragm and hence has no vibration transmission system that transmits vibration through the air chamber 32. The electrodynamic exciter 10 is characterized in this regard. The magnetic circuit assembly 20 has a large mass in comparison to the voice coil 28. Therefore, the vibration system that transmits vibration from the magnetic circuit assembly 20 to the diaphragm 16 has a lower natural frequency than that of the vibration system that transmits vibration from the voice coil 28 to the diaphragm 16.

For this reason, when an electric signal having a frequency in the low frequency audio range is applied to the voice coil 28, the diaphragm 16 is vibrated mainly by vibration from the magnetic circuit assembly 20.

In contrast, when an electric signal having a frequency in the mid and high frequency audio range is applied to the voice coil 28, the diaphragm 16 is vibrated mainly by vibration from the voice coil 28. In this case, the first vibration transmission system including the second suspension 14 and the frame 12 and the second vibration transmission system including the second suspension 14 and the air chamber 32 are parallel to each other with respect to the diaphragm 16. The air chamber 32 of the second vibration transmission system functions as an air damper (because the openings 14a are provided in the center of the second suspension 14). Accordingly, as the vibration frequency of the voice coil 28 increases, the vibration transmissibility becomes high, and the diaphragm 16 is vibrated with an increased amplitude, as compared to the foregoing conventional electrodynamic exciter having no such an element. FIG. 7 is a graph showing such frequency characteristics. It will be understood from the graph that the frequency characteristic curve 46 of the electrodynamic exciter 10 has a high sound pressure level in a frequency band of not lower than 1000 Hz, as compared to the frequency characteristic curve 44 of the conventional electrodynamic exciter.

In the example shown in FIG. 5, the electrodynamic exciter is disposed on a part of the transparent plate 16 which is provided for protection of a liquid crystal display panel 38. The electrodynamic exciter vibrates the whole transparent plate 16 as a diaphragm.

In the illustrated electrodynamic exciter 10, the openings 14a for ventilation are provided in the second suspension 14 to prevent a risk of breakage of the second suspension 14 or the diaphragm 16 that might otherwise be caused by a high pressure produced in the air chamber 32 when the voice coil 28 vibrates with an excessive amplitude. Accordingly, the air chamber 32 functions as an air damper in the above-described second vibration transmission system. If the air chamber 32 is completely sealed without providing the openings 14a, the air chamber 32 functions as an air spring. In this case also, the transmissibility of vibration from the voice coil 28 to the diaphragm 16 increases in comparison to a structure having no air chamber as in the foregoing conventional electrodynamic exciter. In such a case, it is considered that there will be an increase in amplitude (sound pressure) not only in the mid and high frequency audio range but also in the low frequency audio range.

The air chamber 32 also has the function of suppressing excessively large-amplitude vibrations of the voice coil 28 and the second suspension 14 in addition to the above-described functions. Accordingly, high-quality reproduced sound without distortion can be obtained. It is also possible to prevent a generation of noise that would otherwise be caused by departure of the voice coil 28 from an appropriate range of the magnetic gap 30 when a sound of large volume is output, and also prevent damage to the voice coil 28 by contact with the magnetic circuit assembly 20 at the time of outputting a large-volume sound.

The operation, function and characteristics of the electrodynamic exciter 10 according to the first embodiment are substantially as stated above. In the electrodynamic exciter 100 according to the second embodiment, the cap-like member 35 is interposed between the frame 12 and the diaphragm 16. It will, however, be clear without detailed description that the operation, function and characteristics of the electrodynamic exciter 100 are the same as those of the electrodynamic exciter 10.

Although some embodiments of the present invention have been described above, the present invention is not necessarily limited to the described embodiments. For example, the openings 14a provided in the second suspension 14 are to prevent generation of excessive pressure in the air chamber 32. Therefore, the configuration and number of the openings 14a can be determined arbitrarily. The opening area of the openings 14a should, however, be within a range in which the air chamber 32 can function as the above-described air damper or air spring. In addition, the openings 14a are provided to perform the above-described function and hence need not necessarily be provided in the second suspension 14. For example, the openings 14a may be provided in the diaphragm 16 or the cap-like member 35. In the first embodiment, the openings 14a may be provided in a portion of the frame 12 between the second suspension 14 and the diaphragm 16 or in the securing member 34. It is also possible to increase the amplitude level at the high frequency audio band side by applying an expandable-resin member, for example, to the second suspension 14. Although in the foregoing description a transparent plate for protecting the display surface of a liquid crystal display panel is used as the diaphragm 16, a transparent plate for protecting the display surface of an electroluminescence display panel may also be used as the diaphragm 16. The electroluminescence display panel has a transparent insulating substrate of glass, resin or the like. On the obverse side of the substrate are successively formed a transparent electrode of indium tin oxide (ITO), a hole transport layer of a triphenyldiamine derivative, a luminous layer of an alumiquinolinol complex, and a metal electrode of aluminum. A protective layer of an electrically insulating polymer compound is formed to cover the transparent electrode, the hole transport layer, the luminous layer and the metal electrode. With this structure, light is emitted from the reverse side of the transparent insulating substrate. The electrodynamic exciter is provided the back side of a transparent plate provided for protecting the display surface of the display panel. The electrodynamic exciter according to the present invention is also applicable to portable information devices such as PDAs (Personal Digital Assistants), personal computers, and electronic dictionaries, in addition to cellular phones. Transparent plates for protecting the display panels of these portable information devices or the housings of the information devices are also usable as the diaphragm 16.

It should be noted that the present invention is not necessarily limited to the foregoing embodiments but can be modified in a variety of ways without departing from the gist of the present invention.

What is claimed is:

1. An electrodynamic exciter comprising:
a tubular frame;
a magnetic circuit assembly disposed in said frame;
a first suspension that supports said magnetic circuit assembly vibratably in an axial direction of said frame;
a voice coil disposed in said frame to extend in said axial direction and functionally connected to said magnetic circuit assembly; and
a sheet-shaped second suspension provided in said frame so as to intersect the axial direction of said frame, said second suspension having a first surface facing an opening at one end of said frame and a second surface facing said magnetic circuit assembly at a side opposite to said first surface, said second suspension supporting said voice coil on said second surface so that said voice coil is vibratable in the axial direction of said frame;
wherein when an electric signal is applied to said voice coil, said voice coil and said magnetic circuit assembly are vibrated in the axial direction of said frame by magnetic interaction between said voice coil and said magnetic circuit assembly.

2. An electrodynamic exciter according to claim 1, further comprising:
a diaphragm provided so as to close the opening at said one end of said frame, whereby an air chamber is formed between said diaphragm and said second suspension.

3. An electrodynamic exciter according to claim 2, further comprising:
a vent opening that vents an interior of said air chamber to outside air to prevent generation of an excessive pressure in said air chamber when said second suspension vibrates.

4. An electrodynamic exciter according to claim 3, wherein said vent opening is formed in said second suspension.

5. An electrodynamic exciter according to claim 4, wherein said vent opening is formed in a central portion of said second suspension.

6. An electrodynamic exciter according to claim 2, wherein said diaphragm is a transparent plate for protecting a display surface of a liquid crystal display panel or an electroluminescence display panel.

7. An electrodynamic exciter comprising:
a tubular frame;
a magnetic circuit assembly disposed in said frame;
a first suspension that supports said magnetic circuit assembly vibratably in an axial direction of said frame;
a voice coil disposed in said frame to extend in said axial direction and functionally connected to said magnetic circuit assembly;
a sheet-shaped second suspension having a peripheral edge portion secured along a peripheral edge of an opening at one end of said frame so that said second suspension closes said opening, said second suspension having a first surface facing outside said frame and a second surface facing said magnetic circuit assembly at a side opposite to said first surface, said second suspension supporting said voice coil on said second surface so that said voice coil is vibratable in the axial direction of said frame; and
a cap-like member having a diaphragm securing surface portion extending to intersect the axis of said frame at a position outward of the opening at said one end of said frame, said diaphragm securing surface portion having an inside surface facing said second suspension and an outside surface opposite to said inside surface, said inside surface forming an air chamber between itself and the first surface of said second suspension, said outside surface being secured to a diaphragm;
wherein when an electric signal is applied to said voice coil, said voice coil and said magnetic circuit assembly are vibrated in the axial direction of said frame by magnetic interaction between said voice coil and said magnetic circuit assembly, whereby said diaphragm is vibrated through a vibration transmission path including said air chamber.

8. An electrodynamic exciter according to claim 7, further comprising:
a vent opening that vents an interior of said air chamber to outside air to prevent generation of an excessive pressure in said air chamber when said second suspension vibrates.

9. An electrodynamic exciter according to claim 8, wherein said vent opening is formed in said second suspension.

10. An electrodynamic exciter according to claim 9, wherein said vent opening is formed in a central portion of said second suspension.

11. An electrodynamic exciter according to claim 7, wherein said second suspension has an outer peripheral edge portion secured to the peripheral edge of the opening at said one end of said frame, and said cap-like member has an outer peripheral edge portion secured onto said outer peripheral edge portion of said second suspension.

12. An electrodynamic exciter according to claim 7, wherein said cap-like member is made from a sheet-shaped metallic material.

13. An electrodynamic exciter according to claim 7, wherein said diaphragm securing surface portion of said cap-like member has substantially a same size as a portion of said second suspension that is radially inward of said outer peripheral edge portion of said second suspension.

14. An electrodynamic exciter according to claim 7, wherein said diaphragm is a transparent plate for protecting a display surface of a liquid crystal display panel or an electroluminescence display panel.
